(19) United States
(12) Patent Application Publication
(10) Pub. No.: US 2021/0065663 A1
(43) Pub. Date: Mar. 4, 2021

(54) DETACHABLE GUITAR SUPPORT

(71) Applicant: Shenzhen Dedo Music Co., Ltd, Shenzhen (CN)

(72) Inventor: QINGYUN PENG, Zhuzhou (CN)

(21) Appl. No.: 16/566,912

(22) Filed: Sep. 11, 2019

(30) Foreign Application Priority Data
Aug. 30, 2019 (CN) 201910816600.8

(51) Int. Cl. G10G 5/00; F16M 11/24

(52) U.S. Cl. CPC G10G 5/00; F16M 11/245

(57) ABSTRACT

A detachable guitar support includes a first leg which includes a first locating hole and a second locating hole connected with the first locating hole and passing through the first leg, a second leg removably connected to the first leg, a first supporting rod and a second supporting rod. The second leg includes a third locating hole and a fourth locating hole connected with the third locating hole and passing through the second leg. The first supporting rod can pass through the first and second locating holes in turn and then threadedly connect to the first leg, and the second supporting rod can also pass through the third and fourth locating holes in turn and then threadedly connect to the second leg. The present structure can be easily disassembled so that it is occupied a very small space after it's disassembled, which is convenient for carrying and transportation.

### BACKGROUND

### 1. Technical Field

The present disclosure generally relates to support apparatus for supporting musical instruments field, and especially relates to a detachable guitar support for supporting guitars thereon.

### 2. Description of Related Art

A conventional guitar support is a non-removable design so that it should occupy a large space and is difficult to carry and transport. Furthermore, because it is non-removable, it is easy to be damaged due to collision during its transportation.

### SUMMARY

The technical problems to be solved: in view of the shortcomings of the related art, the present disclosure relates to a detachable guitar support which can be easily disassembled so that it is occupied a very small space after it's disassembled, which is convenient for carrying and transportation.

The technical solution adopted for solving technical problems of the present disclosure is:

A detachable guitar support includes a first leg including a first locating hole and a second locating hole connected with the first locating hole and passing through the first leg, a second leg, with an upper end thereof being removably connected to an upper portion of the first leg, including a third locating hole and a fourth locating hole connected with the third locating hole and passing through the second leg, a first supporting rod passing through the first locating hole and the second locating hole in tur and then threadedly connected to the first leg, and a second supporting rod passing through the third locating hole and the fourth locating hole in turn and then threadedly connected to the second leg.

Wherein the first supporting rod includes a first positioning post and a second positioning post formed on an end thereof, the first positioning post received in the first locating hole, the second positioning post tightly fixed with a side of the first positioning post far away from the first supporting rod and passing through the second locating hole to threadedly connect to the second locating hole.

Wherein the detachable guitar support further includes a first locking portion including a first clamping groove formed thereon, the second positioning post passing through the second locating hole and then extending into the first clamping groove to threadedly connect to the first clamping groove.

Wherein the second supporting rod includes a third positioning post and a fourth positioning post formed on an end thereof, the third positioning post received in the third locating hole, the fourth positioning post tightly fixed with a side of the third positioning post far away from the second supporting rod and passing through the fourth locating hole to threadedly connect to the fourth locating hole.

Wherein the detachable guitar support further includes a second locking portion including a second clamping groove formed thereon, the fourth positioning post passing through the fourth locating hole and then extending into the second clamping groove to threadedly connect to the second clamping groove.

Wherein the detachable guitar support further includes a loose-leaf hinge connected between the upper portion of the first leg and the upper end of the second leg, the loose-leaf hinge including a first installing plate tightly fixed with the upper portion of the first leg, and a second installing plate removably connected to the first installing plate and tightly fixed with the upper end of the second leg.

Wherein the detachable guitar support further includes a limiting hinge which includes a first limiting plate tightly fixed with the first leg, and a second limiting plate removably connected to the first limiting plate and tightly fixed with the second leg; when the first leg is rotated relative to the second leg, the first limiting plate is also driven by the first leg to rotate relative to the second limiting plate until an angle between the first limiting plate and the second limiting plate is 180 degree, the first limiting plate can be limited to stop its rotation.

Wherein the detachable guitar support further includes a third supporting rod and a fifth positioning post threadedly connected to the third supporting rod, the first leg including a first arc-surface formed on its bottom portion thereof and a first mounting hole formed on the first arc-surface, the fifth positioning post passing through the third supporting rod and then extending into the first mounting hole to threadedly connect to the first mounting hole so that the third supporting rod is attached onto the first arc-surface.

Wherein the detachable guitar support further includes a fourth supporting rod and a sixth positioning post threadedly connected to the fourth supporting rod, the second leg including a second arc-surface formed on its bottom end thereof and a second mounting hole formed on the second arc-surface, the sixth positioning post passing through the fourth supporting rod and then extending into the second mounting hole to threadedly connect to the second mounting hole so that the fourth supporting rod is attached onto the second arc-surface.

Wherein the first supporting rod includes a first bending portion formed on an opposite end thereof far away from the first and second positioning posts, and the second supporting rod includes a second bending portion, with a same structure as the first bending portion, formed on an opposite end thereof far away from the third and fourth positioning posts, both the first bending portion and the second bending portion bent downward to receive a guitar therein.

The present disclosure provides the advantages as below.

The structure of the present disclosure can be easily disassembled so that it is occupied a very small space after it's disassembled, and has a simple structure so that it can be conveniently installed without any auxiliary tools, which is convenient for carrying and transportation.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, schematic view of the detachable guitar support in accordance with an exemplary embodiment.

FIG. 2 is a schematic view of the detachable guitar support of FIG. 1.

FIG. 3 is a schematic view of a first leg of the detachable guitar support of FIG. 1.

FIG. 4 is a schematic view of a second leg of the detachable guitar support of FIG. 1.

FIG. 5 is a schematic view of a second supporting rod of the detachable guitar support of FIG. 1.

FIG. 6 is a schematic view of a first supporting rod of the detachable guitar support of FIG. 1.

### DETAILED DESCRIPTION

The disclosure is illustrated by way of example and not by way of limitation in the figures of the accompanying drawings, in which like reference numerals indicate similar elements.

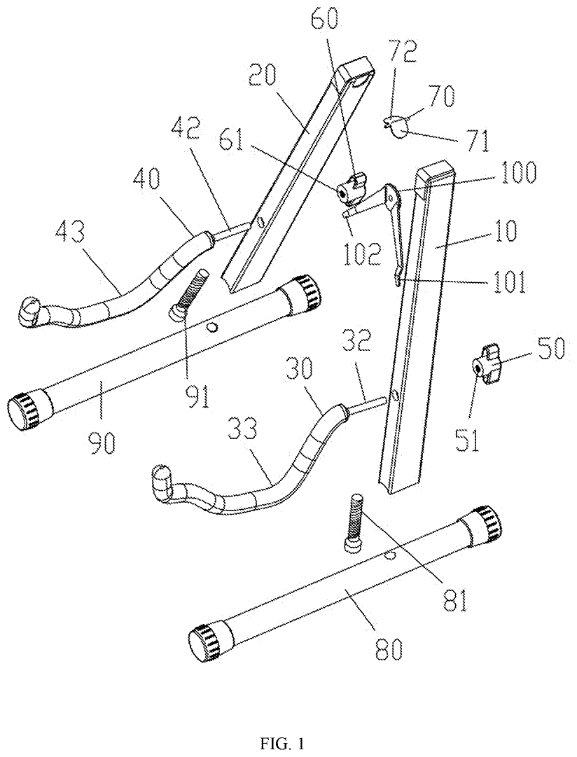

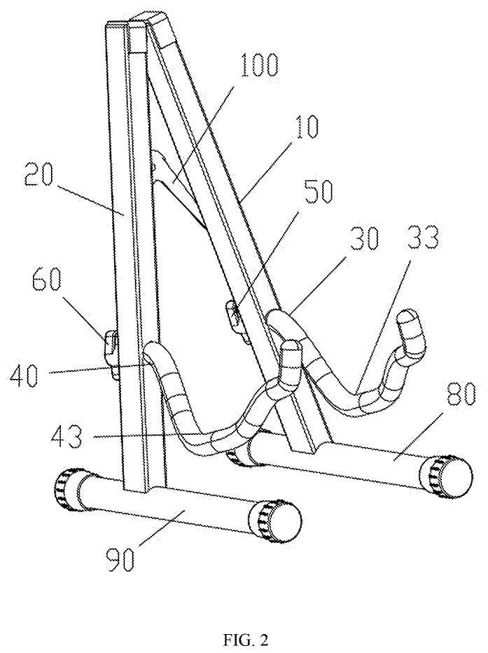

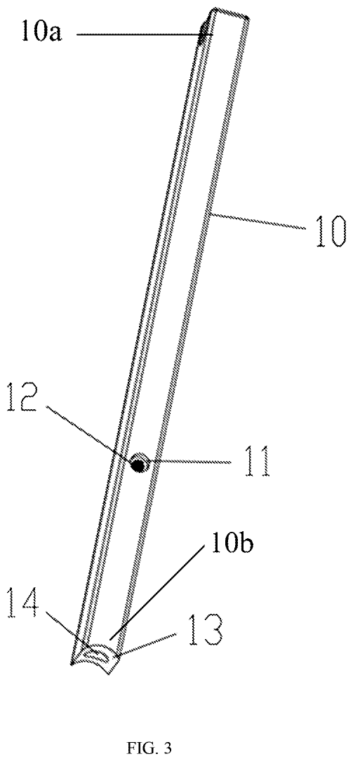

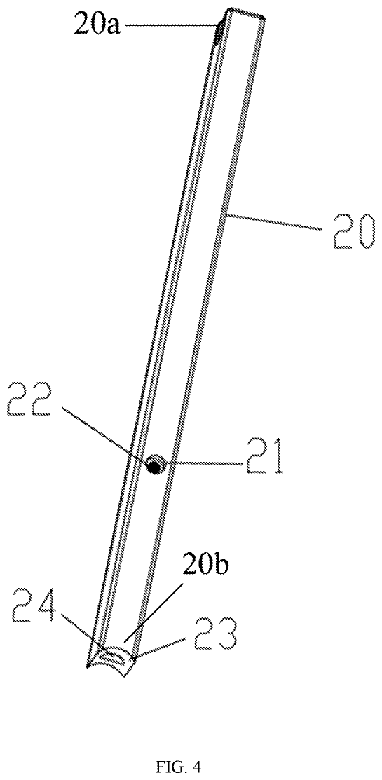

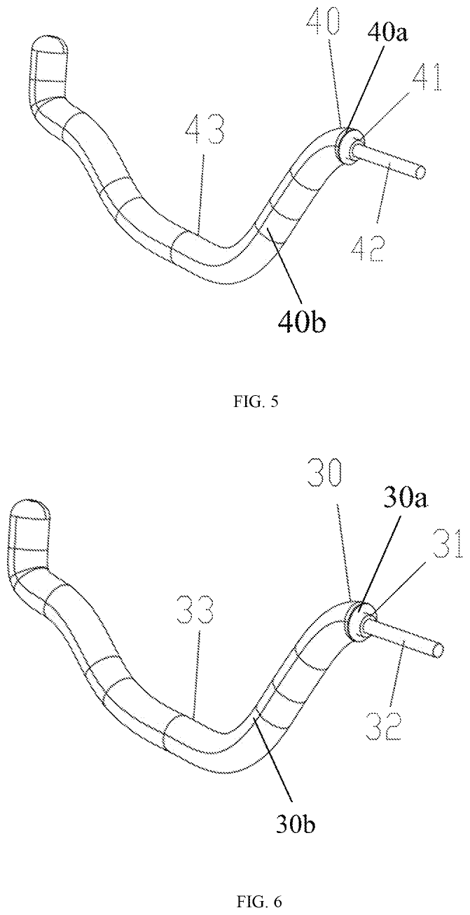

Referring to FIGS. 1-6, a detachable guitar support according to an exemplary embodiment of the present disclosure includes a first leg 10, a second leg 20, a first supporting rod 30 and a fourth supporting rod 40.

The first leg 10, with an upper portion 10a thereof being removably connected to an upper end 20a of the second leg 20, includes a first locating hole 11, and a second locating hole 12 connected with the first locating hole 11 and passing through the first leg 10. The second leg 20 includes a third locating hole 21 and a fourth locating hole 22 connected with the third locating hole 21 and passing through the second leg 20. The first supporting rod 30 passes through the first locating hole 11 and the second locating hole 12 in turn and then is threadedly connected to the first leg 10. The second supporting rod 40 passes through the third locating hole 21 and the fourth locating hole 22 in turn and then is threadedly connected to the second leg 20.

In an exemplary embodiment of the present disclosure, The first supporting rod 30 passes through the first locating hole 11 and the second locating hole 12 in turn and then is threadedly connected to the first leg 10, thus, a fixed connection between the first supporting rod 30 and the first leg 10 can be obtained. The second supporting rod 40 passes through the third locating hole 21 and the fourth locating hole 22 in turn and then is threadedly connected to the second leg 20, thus, a fixed connection between the second supporting rod 40 and the second leg 20 can be also obtained. In this way, the first supporting rod 30 and the second supporting rod 40 can be installed simply by a screw-rotation way so that the installation of the detachable guitar support can be completed without any auxiliary tools, thereby the detachable guitar support can be easily disassembled so that it is occupied a very small space after it's disassembled, which is convenient for carrying and transportation.

Furthermore, the first supporting rod 30 includes a first positioning post 31 and a second positioning post 32 formed on an end 30a thereof. The first positioning post 31 is received in the first locating hole 11, and the second positioning post 32 is tightly fixed with a side of the first positioning post 31 far away from the first supporting rod 30 and passes through the second locating hole 12 to threadedly connect to the second locating hole 12.

In an exemplary embodiment of the present disclosure, the second positioning post 32 is tightly fixed with the first supporting rod 30 and passes through the second locating hole 12 to threadedly connect to the second locating hole 12 so that the first supporting rod 30 is tightly fixed with the first leg 10.

Furthermore, the detachable guitar support further includes a first locking portion 50 including a first clamping groove 51 formed thereon so that the second positioning post 32 can pass through the second locating hole 12 and then extend into the first clamping groove 51 to threadedly connect to the first clamping groove 51.

In an exemplary embodiment of the present disclosure, the first supporting rod 30 can be locked by rotating the first locking portion 50 to limit the displacement of the first supporting rod 30, thereby the first supporting rod 30 can't be detached from the second locating hole 12.

Furthermore, the second supporting rod 40 includes a third positioning post 41 and a fourth positioning post 42 formed on an end thereof. The third positioning post 41 is received in the third locating hole 21, and the fourth positioning post 42 is tightly fixed with a side of the third positioning post 41 far away from the second supporting rod 40 and passes through the fourth locating hole 22 to threadedly connect to the fourth locating hole 22.

In an exemplary embodiment of the present disclosure, the third positioning post 41 is tightly fixed with the second supporting rod 40 and the fourth positioning post 42 passes through the fourth locating hole 22 to threadedly connect to the fourth locating hole 22 so that the second supporting rod 40 is tightly fixed with the second leg 20.

Furthermore, the detachable guitar support further includes a second locking portion 60 including a second clamping groove 61 formed thereon so that the fourth positioning post 42 can pass through the fourth locating hole 22 and then extend into the second clamping groove 61 to threadedly connect to the second clamping groove 61.

In an exemplary embodiment of the present disclosure, the second supporting rod 40 can be locked by rotating the second locking portion 60 so that the displacement of the second supporting rod 40 can be limited, thereby the second supporting rod 40 can't be detached from the fourth locating hole 22.

Furthermore, the detachable guitar support further includes a loose-leaf hinge 70 connected between the upper portion 10a of the first leg 10 and the upper end 20a of the second leg 20. The loose-leaf hinge 70 includes a first installing plate 71 tightly fixed with the upper portion 10a of the first leg 10, and a second installing plate 72 removably connected to the first installing plate 71 and tightly fixed with the upper end 20a of the second leg 20.

In an exemplary embodiment of the present disclosure, the first leg 10 is removably connected to the second leg 20 via the loose-leaf hinge 70 so that the first leg 10 can rotate relative to the second leg 20 to adjust a supporting angle between the first leg 10 and the second leg 20.

Furthermore, the detachable guitar support further includes a limiting hinge 100 which includes a first limiting plate 101 tightly fixed with the first leg 10, and a second limiting plate 102 removably connected to the first limiting plate 101 and tightly fixed with the second leg 20.

In an exemplary embodiment of the present disclosure, when the first leg 10 is rotated relative to the second leg 20, the first limiting plate 101 is also driven by the first leg 10 to rotate relative to the second limiting plate 102 until an angle between the first limiting plate 101 and the second limiting plate 102 is 180 degree, the first limiting plate 101 can be limited to stop its rotation rather than continue to rotate along its original rotation direction.

Furthermore, the detachable guitar support further includes a third supporting rod 80 and a fifth positioning post 81 threadedly connected to the third supporting rod 80. The first leg 10 includes a first arc-surface 13 formed on its bottom portion 10b thereof and a first mounting hole 14 formed on the first arc-surface 13. The fifth positioning post 81 can pass through the third supporting rod 80 and then extend into the first mounting hole 14 to threadedly connect to the first mounting hole 14 so that the third supporting rod 80 is attached onto the first arc-surface 13.

In an exemplary embodiment of the present disclosure, the fifth positioning post 81 is threadedly connected to both the third supporting rod 80 and the first mounting hole 14 so that a fixed connection between the third supporting rod 80 and the first leg 20 can be obtained. The third supporting rod 80 is attached onto the first arc-surface 13 so that the third supporting rod 80 can more firmly connect to the first leg 20. The fifth positioning post 81 passes through the third supporting rod 80 so that one end of the fifth positioning post 81 is received in the third supporting rod 80.

Furthermore, the detachable guitar support further includes a fourth supporting rod 90 and a sixth positioning post 91 threadedly connected to the fourth supporting rod 90. The second leg 20 includes a second arc-surface 23 formed on its bottom end 20b thereof and a second mounting hole 24 formed on the second arc-surface 23. The sixth positioning post 91 can pass through the fourth supporting rod 90 and then extend into the second mounting hole 24 to threadedly connect to the second mounting hole 24 so that the fourth supporting rod 90 is attached onto the second arc-surface 23.

In an exemplary embodiment of the present disclosure, the sixth positioning post 91 is threadedly connected to both the fourth supporting rod 90 and the second mounting hole 24 so that a fixed connection between the fourth supporting rod 90 and the second leg 20 can be obtained. The fourth supporting rod 90 is attached onto the second arc-surface 23 so that the fourth supporting rod 90 can more firmly connect to the second leg 20. The sixth positioning post 91 passes through the fourth supporting rod 90 so that one end of the sixth positioning post 91 is received in the fourth supporting rod 90.

Furthermore, the first supporting rod 30 includes a first bending portion 33 formed on an opposite end 30b thereof far away from the first and second positioning posts 31, 32, and the second supporting rod 40 includes a second bending portion 43 formed on an opposite end 40b thereof far away from the third and fourth positioning posts 41, 42.

In an exemplary embodiment of the present disclosure, the structure of the first bending portion 33 is same as that of the second bending portion 43, and both the first bending portion 33 and the second bending portion 43 are bent downward to receive a guitar therein.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A detachable guitar support comprising:
a first leg comprising a first locating hole and a second locating hole connected with the first locating hole and passing through the first leg;
a second leg with an upper end thereof being removably connected to an upper portion of the first leg, the second leg comprising a third locating hole and a fourth locating hole connected with the third locating hole and passing through the second leg;
a first supporting rod passing through the first locating hole and the second locating hole in turn and then threadedly connected to the first leg; and wherein
a second supporting rod passes through the third locating hole and the fourth locating hole in turn and then threadedly connects to the second leg.

2. The detachable guitar support as claimed in claim 1, wherein the first supporting rod comprises a first positioning post and a second positioning post formed on an end thereof, the first positioning post received in the first locating hole, and the second positioning post tightly fixed with a side of the first positioning post far away from the first supporting rod and passing through the second locating hole to threadedly connect to the second locating hole.

3. The detachable guitar support as claimed in claim 2, wherein the detachable guitar support further comprises a first locking portion comprising a first clamping groove formed thereon, the second positioning post passing through the second locating hole and then extending into the first clamping groove to threadedly connect to the first clamping groove.

4. The detachable guitar support as claimed in claim 3, wherein the second supporting rod comprises a third positioning post and a fourth positioning post formed on an end thereof, the third positioning post received in the third locating hole, the fourth positioning post tightly fixed with a side of the third positioning post far away from the second supporting rod and passing through the fourth locating hole to threadedly connect to the fourth locating hole.

5. The detachable guitar support as claimed in claim 4, wherein the detachable guitar support further comprises a second locking portion comprising a second clamping groove formed thereon, the fourth positioning post passing through the fourth locating hole and then extending into the second clamping groove to threadedly connect to the second clamping groove.

6. The detachable guitar support as claimed in claim 1, wherein the detachable guitar support further comprises a loose-leaf hinge connected between the upper portion of the first leg and the upper end of the second leg, the loose-leaf hinge comprising a first installing plate tightly fixed with the upper portion of the first leg, and a second installing plate removably connected to the first installing plate and tightly fixed with the upper end of the second leg.

7. The detachable guitar support as claimed in claim 1, wherein the detachable guitar support further comprises a limiting hinge which comprises a first limiting plate tightly fixed with the first leg, and a second limiting plate removably connected to the first limiting plate and tightly fixed with the second leg; when the first leg is rotated relative to the second leg, the first limiting plate is also driven by the first leg to rotate relative to the second limiting plate until an angle between the first limiting plate and the second limiting plate is 180 degree, the first limiting plate can be limited to stop its rotation.

8. The detachable guitar support as claimed in claim 4, wherein the detachable guitar support further comprises a third supporting rod and a fifth positioning post threadedly connected to the third supporting rod, the first leg comprising a first arc-surface formed on its bottom portion thereof and a first mounting hole formed on the first arc-surface, the fifth positioning post passing through the third supporting rod and then extending into the first mounting hole to threadedly connect to the first mounting hole so that the third supporting rod is attached onto the first arc-surface.

9. The detachable guitar support as claimed in claim 8, wherein the detachable guitar support further comprises a fourth supporting rod and a sixth positioning post threadedly connected to the fourth supporting rod, the second leg comprising a second arc-surface formed on its bottom end thereof and a second mounting hole formed on the second arc-surface, the sixth positioning post passing through the fourth supporting rod and then extending into the second mounting hole to threadedly connect to the second mounting hole so that the fourth supporting rod is attached onto the second arc-surface.

10. The detachable guitar support as claimed in claim 4, wherein the first supporting rod comprises a first bending portion formed on an opposite end thereof far away from the first and second positioning posts, and the second supporting rod comprises a second bending portion, with a same structure as the first bending portion, formed on an opposite end thereof far away from the third and fourth positioning posts, both the first bending portion and the second bending portion bent downward to receive a guitar therein.
